(19) United States
(12) Patent Application Publication
(10) Pub. No.: US 2008/0008137 A1
(43) Pub. Date: Jan. 10, 2008

(54) METHOD AND SYSTEM OF COMMUNICATION AMONG A PLURALITY OF MOBILE NODES

(75) Inventor: William N. Robinson, Grayslake, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Plantation, FL (US)

(21) Appl. No.: 11/428,658

(22) Filed: Jul. 5, 2006

(51) Int. Cl. H04Q 7/24

(52) U.S. Cl. 370/338

(57) ABSTRACT

A method and system of communication among a plurality of mobile nodes is provided. The method comprises establishing (205) a first node group comprising a first plurality of mobile nodes having a first direction of movement and communicatively coupled within a first network and establishing (210) a second node group comprising a second plurality of mobile nodes having a second direction of movement and communicatively coupled within a second network. The method further comprises establishing (215) a first communication channel within a third network between the first node group and the second node group.

### FIELD OF THE INVENTION

The present invention relates to a method and a system of adhoc communication networking. More specifically, the present invention pertains to a method and system of communication among a plurality of mobile nodes.

### BACKGROUND OF THE INVENTION

An infrastructure-based wireless network typically includes a communication network with fixed and wired gateways. Many infrastructure-based wireless networks employ a mobile unit or host which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In comparison to infrastructure-based wireless networks, such as cellular networks or satellite networks, adhoc networks are self-forming networks which can operate in the absence of any fixed infrastructure, and in some cases the ad hoc network is formed entirely of mobile nodes. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network.

One characteristic of the nodes is that each node can directly communicate over a short range with nodes which are a single “hop” away. Such nodes are sometimes referred to as “neighbor nodes.” When a node transmits packets to a destination node and the nodes are separated by more than one hop (e.g., the distance between two nodes exceeds the radio transmission range of the nodes, or a physical barrier is present between the nodes), the packets can be relayed via intermediate nodes (“multi-hopping”) until the packets reach the destination node. In such situations, each intermediate node routes the packets (e.g., data and control information) to the next node along the route, until the packets reach their final destination. For relaying packets to the next node, each node should maintain routing information collected through conversation with neighboring nodes. The routing information can also be periodically broadcast in the network to reflect the current network topology. Alternatively, to reduce the amount of information transmitted for maintaining accurate routing information, the network nodes may exchange routing information only when it is needed. In an approach known as Mesh Scalable Routing (MSR), nodes periodically send HELLO messages (e.g., once per second) that contain routing information and metrics associated with each route. Mobile nodes use information extracted from the HELLO messages to decide the most efficient manner for performing handoff.

The increased prevalence of such communication technologies facilitates communication among a plurality of mobile nodes for various applications. For example, a plurality of mobile nodes traveling in approximately the same direction, such as cars on a highway, remain in a relatively stable spatial relationship with each other; and thus can communicate via an adhoc network. Conversely, mobile nodes traveling in one direction may have a very transient spatial relationship with mobile nodes traveling in another direction and thus communication may be more challenging.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary embodiment of a communication network comprising a plurality of mobile nodes in accordance with an embodiment of the present invention.

FIG. 2 illustrates a flow diagram of a method of communication among the mobile nodes in the communication network in accordance with an embodiment of the present invention.

FIG. 3 illustrates a flow diagram of a method of establishing a communication channel in accordance with an embodiment of the present invention.

FIG. 4 illustrates a flow diagram of a method of simultaneous handoff between two or more node groups in accordance with an embodiment of the present invention.

FIG. 5 illustrates a flow diagram of a method to communicate within a mobile node in accordance with an embodiment of the present invention.

FIG. 6 illustrates a flow diagram of a method of receiving a content information from a second node group at a mobile node in a first node group in accordance with an embodiment of the present invention.

FIG. 7 illustrates a block diagram of a system for facilitating communication among a plurality of mobile nodes in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to communication among a plurality of mobile nodes in a communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of the system described herein. The non-processor circuits may include, but are not limited to, a radio receiver, a radio transmitter, signal drivers, clock circuits, power source circuits, and user input devices. As such, these functions may be interpreted as steps of a method to perform communication among a plurality of mobile nodes in a communication network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention pertains to a system and method of communication among a plurality of mobile nodes in a communication network. The method comprises establishing a first node group comprising a first plurality of mobile nodes having a first direction of movement and communicatively coupled within a first network; establishing a second node group comprising a second plurality of mobile nodes having a second direction of movement and communicatively coupled within a second network; and establishing a first communication channel within a third network between the first node group and the second node group.

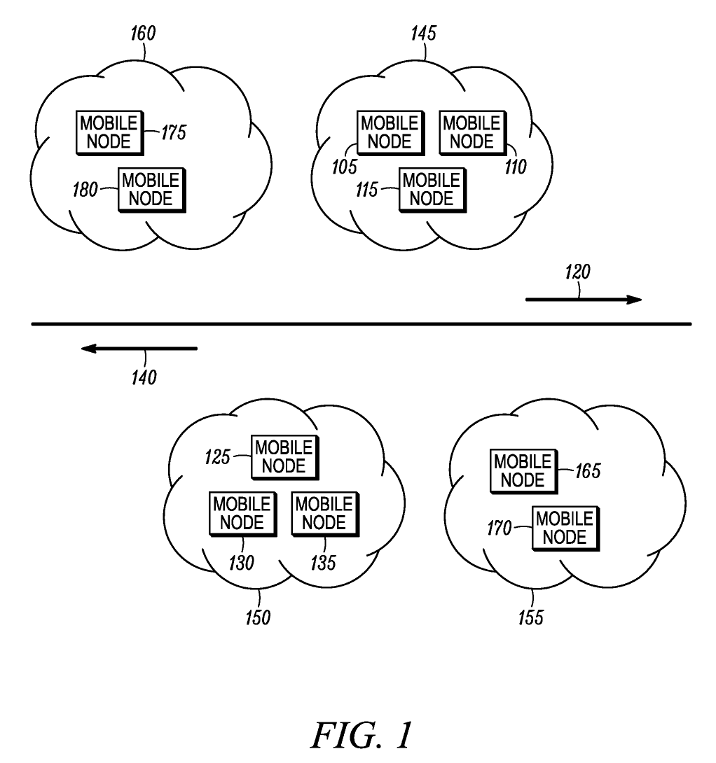

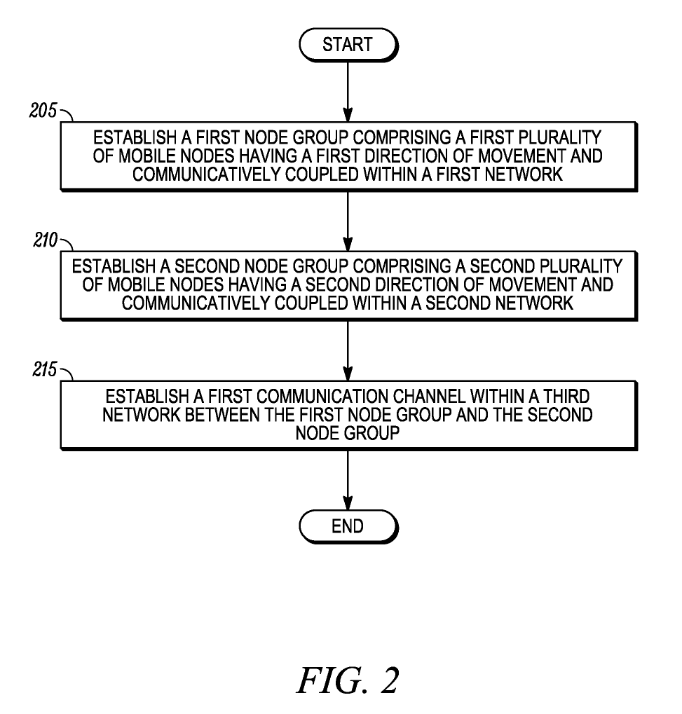

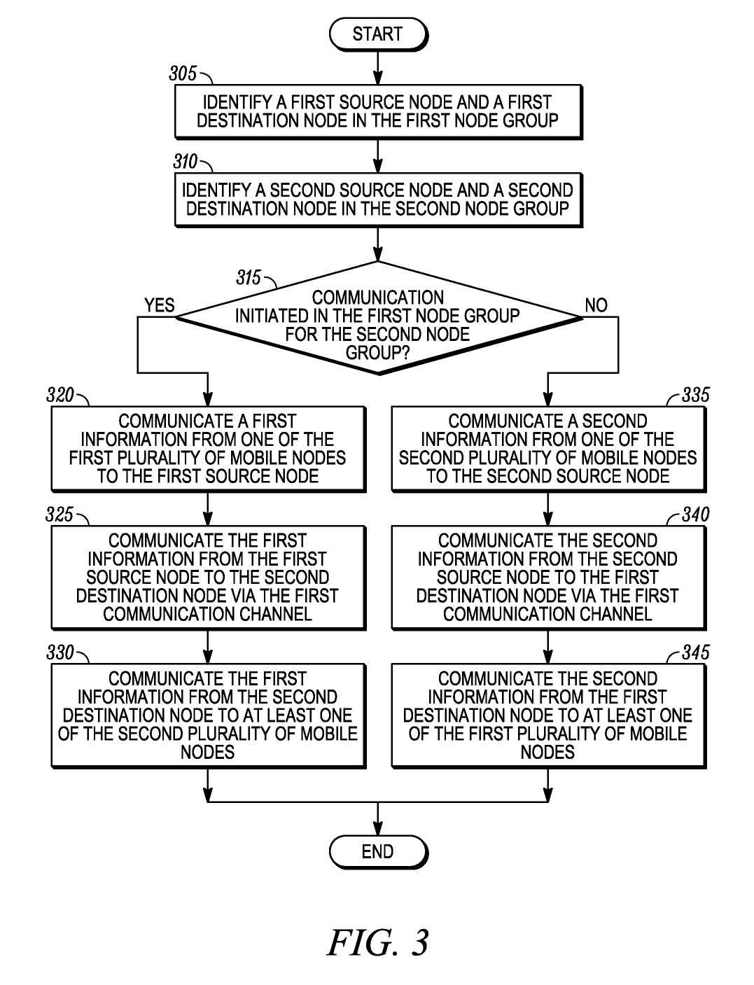

FIG. 1 illustrates an exemplary embodiment of a communication network comprising a plurality of mobile nodes in accordance with an embodiment of the present invention. The communication network comprises a mobile node 105, a mobile node 110, and a mobile node 115 all traveling in approximately a first direction 120. The communication network can further comprise a mobile node 125, a mobile node 130 and a mobile node 135 all traveling in a second direction 140. For example, the mobile nodes can be incorporated into or contained within cars, aircrafts or ships traveling in various directions. Those skilled in the art will realize that a communication network with any number of mobile nodes traveling in various directions is well within the scope of the present invention. A method of communication among the mobile nodes traveling in different directions in a communication network is described in conjunction with FIG. 1, FIG. 2 and FIG. 3 in accordance with the present invention.

Referring now to FIG. 1 and FIG. 2, wherein the FIG. 2 depicts a flow diagram of a method of communication among the mobile nodes in the communication network in accordance with an embodiment of the present invention. The method comprises establishing a first node group 145 comprising the mobile node 105, the mobile node 110 and the mobile node 115 having a direction of movement as the first direction 120 at step 205. The first node group 145 can be established based on a spatial relationship or a directional relationship between the mobile node 105, the mobile node 110 and the mobile node 115. For instance, all the mobile nodes which are in close vicinity of each other or which are moving in approximately the same direction can be grouped to form a node group. In an embodiment of the present invention, a default grouping protocol can be used to dimension the first node group 145. The first node group 145 can also be dimensioned by a cellular network or a wide area network and can be as small as one mobile node.

The mobile node 105, the mobile node 110 and the mobile node 115 are further communicatively coupled within a network by establishing one or more communication routes within the network for communication among the mobile node 105, the mobile node 110 and the mobile node 115.

It will be appreciated by those of ordinary skill in the art that the first node group 145 can communicate within, for example, an adhoc wireless communications network such as a mesh enabled architecture (MEA) network or an 802.11 network (i.e. 802.11a, 802.11b, 802.11g, or 802.11s). It will be appreciated by those of ordinary skill in the art that the first node group 145 in accordance with the present invention can alternatively communicate within any circuit switched or packetized communication network, although a packetized approach is used by way of example for the purposes of the remaining description. For example, the communication network can be a network utilizing packet data protocols such as TDMA (time division multiple access), GPRS (General Packet Radio Service) and EGPRS (Enhanced GPRS).

As can be appreciated by one skilled in the art, the mobile nodes within the first node group 145 are capable of communicating with each other directly, or via one or more other mobile nodes operating as a router or routers for packets being sent between the mobile nodes.

Therefore any mobile node from the first node group 145 can communicate with any other mobile node in the first node group 145. Those skilled in the art will realize that communication among the mobile node 105, the mobile node 110 and the mobile node 115 that are traveling in the first direction 120 is relatively stable with respect to each other.

Similarly, the method comprises establishing a second node group 150 comprising the mobile node 125, the mobile node 130 and the mobile node 135 having a direction of movement as the second direction 140 at step 210. The second node group 150 can also be established based on a spatial relationship or a directional relationship between the mobile node 125, the mobile node 130 and the mobile node 135. The mobile node 125, the mobile node 130 and the mobile node 135 are further communicatively coupled within another network by establishing one or more communication routes within the network for communication among the mobile node 125, the mobile node 130 and the mobile node 135.

The mobile nodes of the second node group 150 can communicate with each other in a manner similar to the mobile nodes in the first node group 145, as described earlier. For instance, the second node group 150 can communicate within, for example, an adhoc wireless communications network such as a mesh enabled architecture (MEA) network or an 802.11 network (i.e. 802.11a, 802.11b, 802.11g, or 802.11s). It will be appreciated by those of ordinary skill in the art that the second node group 150 in accordance with the present invention can alternatively communicate within any packetized communication network. For example, the communication network can be a network utilizing packet data protocols such as TDMA (time division multiple access), GPRS (General Packet Radio Service) and EGPRS (Enhanced GPRS).

As can be appreciated by one skilled in the art, the mobile nodes within the second node group 150 are capable of communicating with each other directly, or via one or more other mobile nodes operating as a router or routers for packets being sent between the mobile nodes.

Therefore, any mobile node from the second node group 150 can communicate with any other mobile node in the second node group 150. Those skilled in the art will realize that communication among the mobile node 125, the mobile node 130 and the mobile node 135 that are traveling in the second direction 140 is relatively stable with respect to each other.

Those skilled in the art will realize that the present invention can facilitate a plurality of mobile nodes to be grouped into any number of node groups, each mobile node in a node group traveling in approximately the same direction as the other mobile nodes in the same node group. However, for exemplary purposes, the embodiment of FIG. 1 depicts four node groups, the first node group 145 and the second node group 150 each comprising three mobile nodes, and a third node group 155 and a fourth node group 160 each comprising two mobile nodes. It will further be appreciated by those of ordinary skill in the art that each node group can comprise any number of mobile nodes in accordance with the present invention.

Next, a first communication channel is established within a network between the first node group 145 and the second node group 150 at step 215. The network, for example, can be a wide area communication network or alternatively can be a wireless local area network. The network can be an adhoc wireless communications network such as a mesh enabled architecture (MEA) network or an 802.11 network (i.e. 802.11a, 802.11b, 802.11g, or 802.11s). Essentially, the network can be any packetized communication network. For instance, the communication network can be a network utilizing packet data protocols such as TDMA (time division multiple access), GPRS (General Packet Radio Service) and EGPRS (Enhanced GPRS). For example, the first communication channel can be established using a cellular network or a cellular intermediary between the first node group 145 and the second node group 150. However, those skilled in the art will realize that the first node group 145 can also be capable of communicating with the second node group 150 using a short-range network, such as an 802.11b or 802.11g network. Moreover, the cellular network can instruct the mobile nodes in the first node group 145 and in the second node group 150 to use the cellular network, a mid-range wireless network or a short-range wireless network depending on the choice of a cellular operator. Those skilled in the art will realize that the first communication channel comprises one or more mobile nodes from the first node group 145 and one or more mobile nodes from the second node group 150. This enables each of the mobile nodes from the first node group 145 to communicate with each of the mobile nodes form the second node group 150 using the first communication channel. For example, the mobile node 105 traveling in first direction 120 may wish to communicate with the mobile node 130 traveling in the second direction 140. In an embodiment of the present invention, the first communication channel may comprise the mobile node 105, the mobile node 115, the mobile node 125 and the mobile node 130. The mobile node 105 can communicate with the mobile node 130 using this first communication channel.

Those skilled in the art will realize that a communication channel can be dynamically changed depending on at least one predetermined criterion. In an embodiment of the present invention, the at least one predetermined criterion can be setting a predetermined threshold time interval for the communication channel. For instance, in an embodiment, the communication channel can be established in such a way that the communication channel is sustained at least for the predetermined threshold time interval. In other embodiments, the communication channel can be established such that a best possible performance is obtained for the communication channel in terms of Bit Error Rate, Signal to Noise ratio, Block Error Rate, Packet retry frequency or Round trip delay.

Referring now to FIG. 3, a flow diagram of a method of establishing a first communication channel is shown in accordance with an embodiment of the present invention. The method comprises identifying a first source node and a first destination node in the first node group 145 at step 305. The first communication channel can comprise either or both of the first source node and the first destination node. Similarly, a second source node and a second destination node are identified in the second node group 150 at step 310. The first communication channel can comprise either or both of the second source node and the second destination node.

The first source node, the first destination node, the second source node and the second destination node are identified based on one or more parameters associated with each of the mobile nodes in the first node group 145 and the mobile nodes in the second node group 150. The one or more parameters can comprise, but are not limited to, an average number of communication hops for communication within the associated network, a spatial position relative to the other mobile nodes within a node group, a spatial position relative to an adjacent node group, predicted stability of a communication channel at a mobile node in the node group, available bit rate supported by a mobile node in the node group, authorization status of a mobile node in the node group or subscription rights enabling access to available radio frequency. Also, the first source node, the first destination node, the second source node and the second destination node can be identified such that the first communication channel can be sustained at least for a predetermined time interval. Moreover, the first source node, the first destination node, the second source node and the second destination nodes can be identified such that the average number of communication hops can be minimized. In an embodiment of the present invention, a plurality of mobile nodes in a node group can negotiate and resolve which mobile node should be the source node and which mobile node should be the destination node. In an embodiment of the present invention, a same mobile node can be identified as a source node and a destination node in a node group.

The first source node and the first destination node are selected by comparing the one or more parameters associated with each of the mobile nodes in the first node group 145. Similarly, the second source node and the second destination node are selected by comparing the one or more parameters associated with each of the mobile nodes in the second node group 150. For example, in the embodiment depicted in FIG. 1, the first source node as well as the first destination node can be identified as the mobile node 115 and the second source node as well as the second destination node can be identified as the mobile node 125. This way the average number of communication hops can be minimized.

Next, if one or more mobile nodes from a node group wish to communicate with one or more mobile nodes from another node group, it is determined in which node group the communication is being initiated at step 315. If at step 315 it can be determined that one or more mobile nodes from the first node group 145 wishes to communicate with one or more mobile nodes from the second node group 150. The mobile node from the first node group 145 can communicate information to the first source node, at step 320, via a communication route established within the first node group 145. The information is then communicated from the first source node to the second destination node via the first communication channel at step 325. The information from the second destination node is then communicated to the one or more mobile nodes from the second node group 150, at step 330, via a communication route established within the second node group 150. Those skilled in the art will appreciate that the mobile nodes from the second node group 150 can communicate an information to the mobile nodes from the first node group 145 in a similar manner. However, in this case, the information is communicated from one of the mobile nodes in the second node group 150 to the second source node at step 335. The second source node communicates the information to the first destination node of the first node group 145 at step 340. The first destination node then communicates the information to one or more mobile nodes in the first node group 145 at step 345.

For example, if the mobile node 130 wishes to communicate with the mobile node 105, the mobile node 130 can send packets to the mobile node 125, which is the second source node. The mobile node 125 can then forward the packets to the mobile node 115, which is the first destination node. The mobile node 115 can then finally send the packets to the mobile node 105. Thus, in this case the first communication channel comprises the mobile node 130, the mobile node 125, the mobile node 115 and the mobile node 105.

In an embodiment of the present invention, a mobile node in a node group can broadcast information content. For example, the mobile node 105 can broadcast information content comprising traffic condition. The information content can be broadcasted to the mobile node 110 and the mobile node 115 in the first node group 145 via the communication route established within the first node group 145. The mobile node 115 can be the first source node. The mobile node 115, thus, forwards the information content to the second destination node, which is say the mobile node 125. The mobile node 125 can forward the information content to each of the mobile nodes in the second node group 150 using the communication route established within the second node group 150. In an embodiment of the present invention, the first source node can forward the information content to the destination nodes of all the node groups that the first node group 145 has a communication channel with. Also, the second destination node can forward the information content to the other node groups that the second node group 150 has a communication channel with, and so on. This can facilitate an adhoc broadcast of the information content.

Further, as mentioned earlier, the communication channel can be changed dynamically depending on at least one predetermined criterion. Also, the source node and a destination node of a node group can be changed dynamically with time depending on, for example, the position of the other node group or the network conditions of the adhoc wireless communication network. Therefore, while the first node group 145 and the second node group 150 are traveling in different directions, the first communication channel, the first source node, the first destination node, the second source node and the second destination node can dynamically be changed so that the first communication channel can be sustained for at least a predetermined threshold time interval.

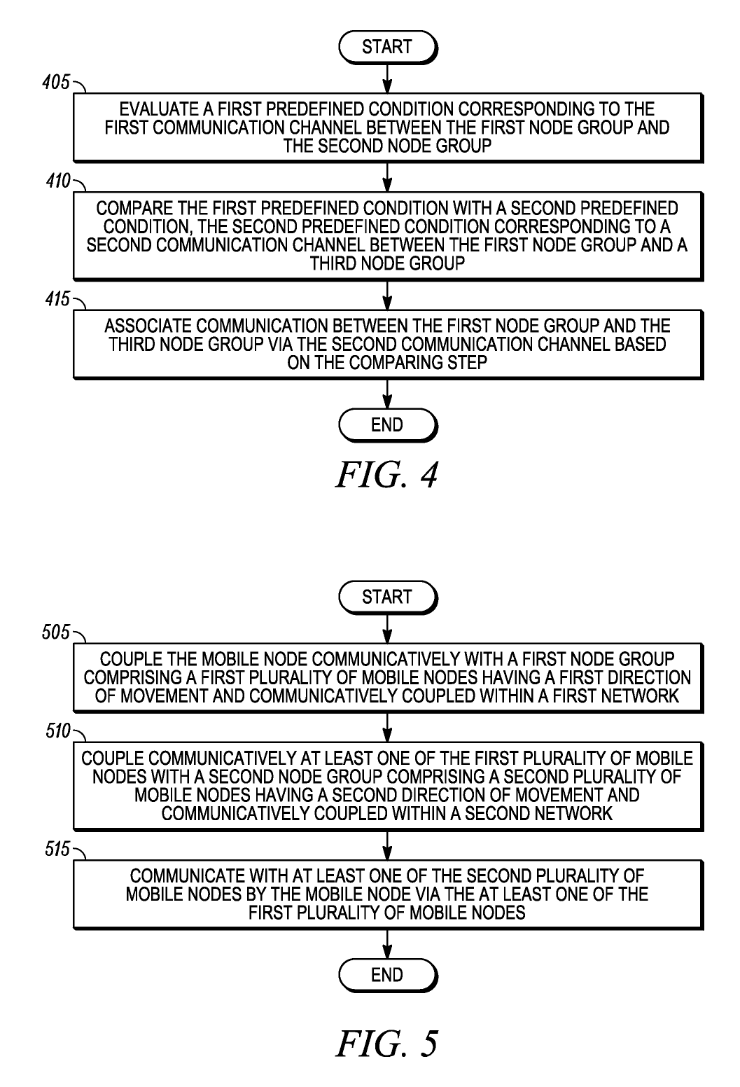

Referring now to FIG. 4, a flow diagram of a method of simultaneous handoff between two or more node groups is depicted in accordance with an embodiment of the present invention. In accordance with the embodiment depicted in FIG. 1, FIG. 2 and FIG. 3, a first communication channel is established between the first node group 145 and the second node group 150. This implies that the first node group 145 is communicatively coupled to the second node group 150. Next, if the first node group 145 travels further ahead in the first direction 120 or the second node group 150 travels further ahead in the second direction 140, the first node group 145 and the second node group 150 can lose their association with each other. This loss of association can cause the first communication channel to break and an ongoing communication between one or more nodes in the first node group 145 and one or more nodes in the second node group 150 can end abruptly. In order to avoid the communication to be disrupted, the present invention allows simultaneous handoff for the first node group 145 and the second node group 150. A frequency of the handoff can be established using a priori standard protocol. If a third node group 155 is traveling approximately in the second direction 140, the first node group 145 is likely to come into a vicinity of the third node group 155. Similarly, if a fourth node group 160 is traveling approximately in the first direction 120, the second node group 150 is likely to come in a vicinity of the fourth node group 160. A handoff of the first node group 145 to the third node group 155 and a handoff of the second node group 150 to the fourth node group 160 can happen simultaneously. The third node group 155 comprises a mobile node 165 and a mobile node 170 whereas the fourth node group 160 comprises a mobile node 175 and a mobile node 180.

Referring back to FIG. 4, before handing off an association from one node group to another, a first predefined condition corresponding to the first communication channel is evaluated at step 405. The first predefined condition can be, but is not limited to, signal strength of the first communication channel, reconfiguration of the first node group or the second node group due to departure or arrival of mobile nodes within the first node group or the second node group, Bit Error rate of the first communication channel, Round trip delay corresponding to the first communication channel, Signal to noise ratio of the first communication channel, Block error rate of the first communication channel, Packet retry frequency of the first communication channel or interference in the first communication channel. The first predefined condition is, then, compared with a second predefined condition at step 410. The second predefined condition corresponds to a second communication channel between the first node group 145 and the third node group 155. The second predefined condition can be signal strength of the second communication channel. Those skilled in the art will realize that the first predefined condition can be compared with predefined conditions corresponding to communication channels between the first node group 145 and a plurality of node groups in the vicinity of the first node group 145. Upon comparing the first predefined condition and the second predefined condition, it is determined if the second predefined condition is better than the first predefined condition, for instance if the signal strength of the second communication channel is better than the signal strength of the first communication channel. If the second predefined condition is better than the first predefined condition, a communication is associated between the first node group 145 and the third node group 155 via the second communication channel.

Further, the communication between the first node group 145 and the second node group 150 can be disassociated. Next, the first predefined condition can be compared with a fourth predefined condition. The fourth predefined condition can correspond to a third communication channel between the second node group 150 and the fourth node group 160. If the fourth predefined condition is better than the first predefined condition, a communication can be associated between the second node group 150 and the fourth node group 160 via the third communication channel. Moreover, the steps of associating communication between the first node group 145 and the third node group 155 and between the second node group 150 and the fourth node group 160 can be carried out simultaneously.

Referring now to FIG. 5, a flow diagram of a method to communicate within a mobile node is shown in accordance with an embodiment of the present invention. The method described in FIG. 5 enables a new mobile node to couple with a node group, such that the new mobile node becomes a part of a plurality of mobile nodes in the node group. For instance, a new mobile node can be traveling in approximately the first direction 120. If the new mobile node comes in the vicinity of the first node group 150, the new mobile node can communicatively couple with the first node group 145 at step 505. The first node group 145 now comprises the new mobile node in addition to the first plurality of mobile nodes. Also, the new mobile node and the first plurality of mobile nodes are communicatively coupled within a first network, as mentioned earlier. The new mobile node can communicate with any of the first plurality of mobile nodes in the first node group 145 using a communication route in the first node group 145.

Further, at step 510, one or more of the first plurality of mobile nodes are communicatively coupled with the second node group 150. This enables each of the mobile nodes in the first node group 145 to communicate with a second plurality of mobile nodes. The second plurality of mobile nodes comprises the mobile node 125, the mobile node 130 and the mobile node 135, as mentioned earlier. The second plurality of mobile nodes are communicatively coupled within a second network using a communication route.

Next, at step 515, the new mobile node, which is a part of the first node group 145, can communicate with each of the second plurality of mobile nodes via the one or more of the first plurality of mobile nodes that is communicatively coupled to the second node group 150.

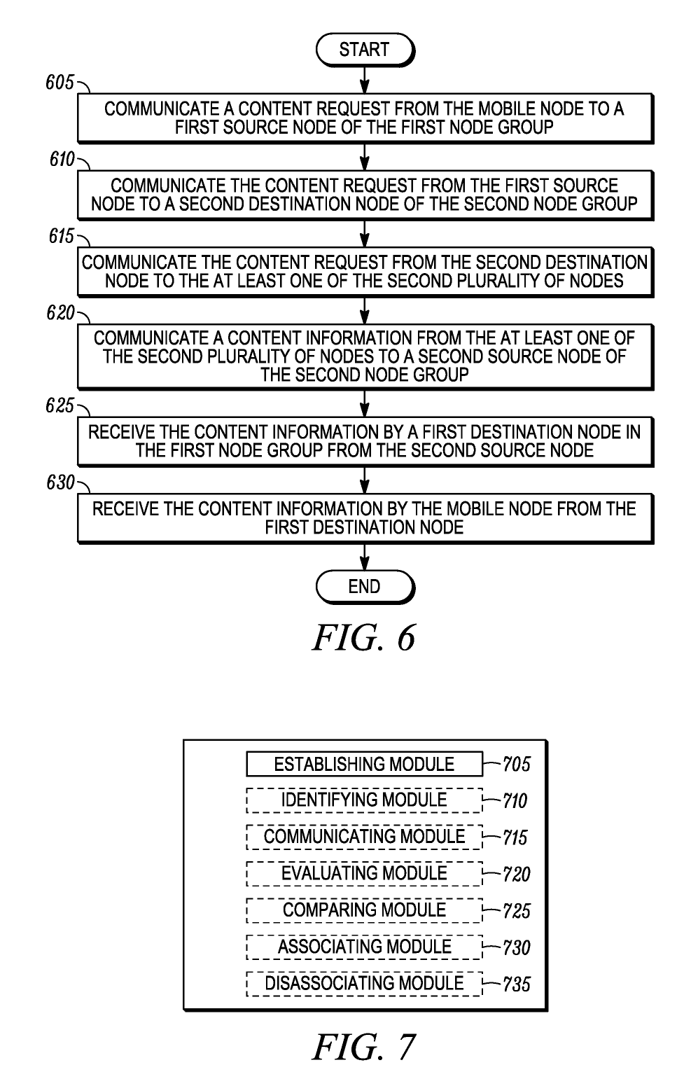

Referring now to FIG. 6, a flow diagram of a method of receiving a content information from the second node group 150 at a mobile node in the first node group 145 in accordance with an embodiment of the present invention. As described in FIG. 3, a first source node and a first destination node are identified in the first node group 145. Also, a second source node and a second destination node are identified in the second node group 150. A mobile node in the first node group 145 may wish to receive a content information from any mobile node in the second node group 150. For example, the new mobile node, which is communicatively coupled with the first node group in the method of FIG. 5, may need a content information from the mobile node 135 in the second node group 150. The new mobile node can communicate a content request to the first source node at step 605. The content request can be forwarded from the new mobile node to the first source node via a communication route established in the first node group 145. The first source node then communicates the content request to the second destination node at step 610. The content request can be sent to the second destination node via a communication channel established between the first node group 145 and the second node group 150. The content request is communicated from the second destination node to the mobile node 135 at step 615. The content request can be passed on from the second destination node to the mobile node 135 via a communication route established in the second node group 150.

Further, a content information corresponding to the content request can be communicated from the mobile node 135 to the second source node at step 620. The content information can then be received by the first destination node from the second source node at step 625. Finally, the new mobile node receives the desired content information from the first destination node at step 630.

Referring now to FIG. 7, a block diagram of a system for facilitating communication among a plurality of mobile nodes is shown in accordance with an embodiment of the present invention. The system can reside on one or more mobile nodes, for example the system can reside on at least the mobile node 115. The system can comprise an establishing module 705. The establishing module 705 can be configured for establishing the first node group 145 comprising the mobile node 105, the mobile node 110 and the mobile node 115, all having a direction of movement as the first direction 120. Specifically, the establishing module 705 can detect the mobile nodes that have certain spatial relationship and a certain directional relationship with the mobile node 115. For example, the establishing module 705 can detect the mobile node 105 and the mobile node 110 to be in the vicinity of the mobile node 115 and traveling approximately the same direction. The establishing module 705, then, established the first node group 145 comprising the mobile node 105, the mobile node 110 and the mobile node 115. In an embodiment of the present invention, the establishing module 705 can reside on a centralized controller in the cellular network. In the absence of the cellular network, a default grouping protocol can be used by the establishing module 705 to dimension a node group. The maximum number of mobile node to be grouped together in a node group can also be defined by the default grouping protocol or by the centralized controller. The minimum number of mobile nodes in a node group can also be one.

The establishing module 705 further communicatively couples the mobile node 105, the mobile node 110 and the mobile node 115 within a network by establishing one or more communication routes within the network for communication among the mobile node 105, the mobile node 110 and the mobile node 115.

The first node group 145 can communicate within, for example, an adhoc wireless communications network such as a mesh enabled architecture (MEA) network or an 802.11 network (i.e. 802.11a, 802.11b, 802.11g, or 802.11s). It will be appreciated by those of ordinary skill in the art that the first node group 145 in accordance with the present invention can alternatively communicate within any packetized communication network. For example, the communication network can be a network utilizing packet data protocols such as TDMA (time division multiple access), GPRS (General Packet Radio Service) and EGPRS (Enhanced GPRS).

As can be appreciated by one skilled in the art, the mobile nodes within the first node group 145 are capable of communicating with each other directly, or via one or more other mobile nodes operating as a router or routers for packets being sent between the mobile nodes.

Therefore any mobile node from the first node group 145 can communicate with any other mobile node in the first node group 145. Those skilled in the art will realize that communication among the mobile node 105, the mobile node 110 and the mobile node 115 that are traveling in the first direction 120 is relatively stable with respect to each other.

The establishing module 705 also establishes the second node group 150 comprising the mobile node 125, the mobile node 130 and the mobile node 135, all having a direction of movement as the second direction 140. The establishing module 705 can reside on one of the mobile nodes in the second node group 150 or on a centralized controller. The establishing module 705 further communicatively couples the mobile node 125, the mobile node 130 and the mobile node 135 within a network by establishing one or more communication routes within the network for communication among the mobile node 125, the mobile node 130 and the mobile node 135.

The establishing module 705 also establishes a first communication channel within a network between the first node group 145 and the second node group 150. For instance, the establishing module 705 residing on the mobile node 115 can detect the second node group 150 to be in the vicinity of the first node group 145. The establishing module 705 can then establish a first communication channel between the first node group 145 and the second node group 150. Those skilled in the art will realize that the establishing module 705 can also be configured to establish communication channels between a plurality of node groups at particular time instant. The network in which the first node group 145 and the second node group 150 communicate can be a wide area communication network or alternatively can be a wireless local area network. The network can be an adhoc wireless communications network such as a mesh enabled architecture (MEA) network or an 802.11 network (i.e. 802.11a, 802.11b, 802.11g, or 802.11s). Essentially, the network can be any packetized communication network. For instance, the communication network can be a network utilizing packet data protocols such as TDMA (time division multiple access), GPRS (General Packet Radio Service) and EGPRS (Enhanced GPRS). For example, the first communication channel between the first node group 145 and the second node group 150 can be established using a cellular network or a cellular intermediary between the first node group 145 and the second node group 150. However, those skilled in the art will realize that the first node group 145 can also be capable of communicating with the second node group 150 using a short-range network, such as an 802.11b or 802.11 g network. Moreover, the cellular network can instruct the mobile nodes in the first node group 145 and in the second node group 150 to use the cellular network, the mid-range wireless network or the short-range wireless network depending on the choice of a cellular operator. Those skilled in the art will realize that the first communication channel comprises one or more mobile nodes from the first node group 145 and one or more mobile nodes from the second node group 150. This enables each of the mobile nodes from the first node group 145 to communicate with each of the mobile nodes form the second node group 150 using the first communication channel.

The system further comprises an identifying module 710. The identifying module 710 can reside on at least one mobile node or on a centralized controller. The identifying module 710 is configured for identifying a first source node and a first destination node in the first node group 145 and a second source node and a second destination node in the second node group 150. Each of the mobile nodes in the first node group 145 and in the second node group 150 can include one or more associated parameters. The one or more parameters can comprise an average number of communication hops for communication within the associated network. Also, the first source node, the first destination node, the second source node and the second destination node can be identified such that the first communication channel can be sustained at least for a predetermined time interval. Moreover, the first source node, the first destination node, the second source node and the second destination node can be identified such that the average number of communication hops can be minimized. In an embodiment of the present invention, identifying modules, such as the identifying module 710, residing on a plurality of mobile nodes in a node group can negotiate and resolve which mobile node should be the source node and which mobile node should be the destination node.

The identifying module 710 can identify the first source node and the first destination node for the first node group 145 and the second source node and the second destination node for the second node group 150 by comparing the one or more parameters. Those skilled in the art will realize that in an embodiment of the present invention, the source node and the destination node for a node group can be a same mobile node.

The first communication channel between the first node group 145 and the second node group 150 is established by the establishing module 705 such that the first communication channel comprises either or both of the first source node and the first destination node and either or both of the second source node and the second destination node. A communicating module 715 is configured for communicating information from at least one of the mobile nodes in the first node group 145 to the first source node. The communicating module 715 then communicates the information from the first source node to the second destination node of the second node group 150 via the first communication channel established by the establishing module 705. The communicating module 715 further communicates the information from the second destination node to one or more of the mobile nodes of the second node group 150.

For example, the identifying module 710 can identify the mobile node 115 as the first source node as well as the first destination node and the mobile node 125 as the second source node as well as the second destination node based on the parameters. Now, if the mobile node 105 wishes to communicate information to the mobile node 135, the communicating module 715 sends the information from the mobile node 105 to the mobile node 115, which is the first source node. The communicating module 715 then communicates the information to the mobile node 125, which is the second destination node. The information is then passed on by the communicating module 715 to the mobile node 135. Those skilled in the art will appreciate that the communicating module 715 can enable one or more mobile nodes from the second node group 150 to communicate information to one or more mobile nodes from the first node group 145 in a similar manner.

The system further comprises an evaluating module 720. The evaluating module 720 evaluates a first predefined condition corresponding to the first communication channel between the first node group 145 and the second node group 150. A comparing module 725 then compares the first predefined condition with a second predefined condition. The second predefined condition corresponds to a second communication channel between the first node group 145 and the third node group 155. Those skilled in the art will realize that the first predefined condition can be compared with predefined conditions corresponding communication channels between the first node group 145 and a plurality of node groups in the vicinity of the first node group 145. An associating module 730 associates communication between the first node group 145 and the third node group 155 if the second predefined condition is better than the first predefined condition. This transfer of association from the second node group 150 to the third node group 155 is known in the art as a handoff. A frequency of the handoff can be established using a priori standard protocol.

An embodiment of the present invention comprises a disassociating module 735. The disassociating module 735 can disassociate communication between the first node group 145 and the second node group 150. The comparing module 725 further compares the first predefined condition with a fourth predefined condition. The fourth predefined condition can correspond to a third communication channel between the second node group 150 and the fourth node group 160. If the fourth predefined condition is better than the first predefined condition, the associating module 730 associates the second node group 150 and the fourth node group 160. In an embodiment of the present invention, the associating module 730 can simultaneously associate communication between the first node group 145 and the third node group 155 and between the second node group 150 and the fourth node group 160.

Those skilled in the art will realize that the system can reside on one or more mobile nodes or on a centralized controller in the cellular network. In an embodiment of the invention, the system can reside on each mobile node participating in the adhoc communication. In this embodiment, the systems residing on various mobile nodes communicate with each other to mutually decide on a node group, a source node, a destination node, the frequency of handoff and the predefined condition for a handoff.

The various embodiments of the present invention, thus, provide a method and a system to achieve a reliable communication between mobile nodes traveling in different directions without incurring excessive control signaling due to a brief transient relationship between the mobile nodes.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the dependency of this application and all equivalents of those claims as issued.

What is claimed is:

1. A method of communication among a plurality of mobile nodes comprising:
establishing a first node group comprising a first plurality of mobile nodes having a first direction of movement and communicatively coupled within a first network;
establishing a second node group comprising a second plurality of mobile nodes having a second direction of movement and communicatively coupled within a second network; and
establishing a first communication channel within a third network between the first node group and the second node group.

2. A method of communication among a plurality of mobile nodes as claimed in claim 1, wherein the first network comprises a first adhoc wireless communication network, wherein the second network comprises a second adhoc wireless communication network, and wherein the third network comprises a wide area communication network,

3. A method of communication among a plurality of mobile nodes as claimed in claim 1, wherein the establishing the first communication channel step comprises setting a predetermined threshold time interval, the method further comprising:
sustaining the first communication channel for the predetermined threshold time interval.

4. A method of communication among a plurality of mobile nodes as claimed in claim 1, wherein the establishing the first node group further comprises:
establishing the first node group based on at least one of a spatial relationship and a directional relationship between the first plurality of mobile nodes.

5. A method of communication among a plurality of mobile nodes as claimed in claim 4, wherein the establishing the first node group further comprises:
establishing at least one communication route within the first network for communication among the first plurality of mobile nodes.

6. A method of communication among a plurality of mobile nodes as claimed in claim 1, wherein the establishing the second node group further comprises:
establishing the second node group based on at least one of a spatial relationship and a directional relationship between the second plurality of mobile nodes.

7. A method of communication among a plurality of mobile nodes as claimed in claim 6, wherein the establishing the second node group further comprises:
establishing at least one communication route within the second network for communication among the second plurality of mobile nodes.

8. A method of communication among a plurality of mobile nodes as claimed in claim 1, wherein the first communication channel comprises at least one first mobile node of the first node group and at least one second mobile node of the second node group.

9. A method of communication among a plurality of mobile nodes as claimed in claim 1, further comprising:
identifying a first source node and a first destination node in the first node group, wherein the first communication channel comprises at least one of the first source node and the first destination node; and
identifying a second source node and a second destination node in the second node group, wherein the first communication channel comprises at least one of the second source node and the second destination node.

10. A method of communication among a plurality of mobile nodes as claimed in claim 9, wherein each of the first plurality of mobile nodes and the second plurality of mobile nodes includes one or more associated parameters, and wherein the identifying of the first source node, the first destination node, the second source node, and the second destination node comprises selecting each of the first source node, the first destination node, the second source node, and the second destination node by comparing the one or more parameters.

11. A method of communication among a plurality of mobile nodes as claimed in claim 10 wherein the one or more parameters comprises at least one of an average number of communication hops for communication within the associated network, a spatial relationship of the plurality of mobile nodes in the associated network, a spatial relationship between the first node group and the second node group, a predicted stability of the first communication channel at a mobile node in at least one of the first node group and the second node group, an available bit rate supported by at least one mobile node in at least one of the first node group and the second node group, an authorization status of at least one mobile node in at least one of the first node group and the second node group and subscription rights enabling access to available radio frequency.

12. A method of communication among a plurality of mobile nodes as claimed in claim 9 further comprising:
communicating a first information from one of the first plurality of mobile nodes to the first source node via the first network;
communicating the first information from the first source node to the second destination node via the first communication channel; and
communicating the first information from the second destination node to at least one of the second plurality of mobile nodes via the second network.

13. A method of communication among a plurality of mobile nodes as claimed in claim 12 further comprising:
communicating a second information from one of the second plurality of mobile nodes to the second source node via the second network;
communicating the second information from the second source node to the first destination node via the first communication channel; and
communicating the second information from the first destination node to at least one of the first plurality of mobile nodes via the first network.

14. A method of communication among a plurality of mobile nodes as claimed in claim 1, further comprising:
evaluating a first predefined condition, the first predefined condition corresponding to the first communication channel between the first node group and the second node group;
comparing the first predefined condition with a second predefined condition, the second predefined condition corresponding to a second communication channel between the first node group and a third node group; and
associating communication between the first node group and the third node group via the second communication channel based on the comparing step.

15. A method of communication among a plurality of mobile nodes as claimed in claim 14 further comprising:
disassociating communication via the first communication channel between the second node group and the first node group.

16. A method of communication among a plurality of mobile nodes as claimed in claim 15 further comprising:
comparing the first predefined condition with a fourth predefined condition, the fourth predefined condition corresponding to a third communication channel between the second node group and a fourth node group; and
associating communication between the second node group and the fourth node group via the third communication channel based on the comparing step.

17. A system for facilitating communication among a plurality of mobile nodes, the system comprising:
an establishing module, the establishing module configured for:
establishing a first node group comprising a first plurality of mobile nodes having a first direction of movement and communicatively coupled within a first network;
establishing a second node group comprising a second plurality of mobile nodes having a second direction of movement and communicatively coupled within a second network; and
establishing a first communication channel within a third network between the first node group and the second node group.

18. A system for facilitating communication among a plurality of mobile nodes as claimed in claim 17 further comprises:
an identifying module, the identifying module configured for:
identifying a first source node and a first destination node in the first node group, wherein the first communication channel comprises at least one of the first source node and the first destination node; and
identifying a second source node and a second destination node in the second node group, wherein the first communication channel comprises at least one of the second source node and the second destination node.
a communicating module, the communicating module configured for:
communicating a first information from one of the first plurality of mobile nodes to the first source node via the first network;
communicating the first information from the first source node to the second destination node via the first communication channel; and
communicating the first information from the second destination node to at least one of the second plurality of mobile nodes via the second network.

19. A communicating module as claimed in claim 18 further configured for:
communicating a second information from one of the second plurality of mobile nodes to the second source node via the second network;
communicating the second information from the second source node to the first destination node via the first communication channel; and
communicating the second information from the first destination node to at least one of the first plurality of mobile nodes via the first network.

20. A system for facilitating communication among a plurality of mobile nodes as claimed in claim 17 further comprises:
an evaluating module, the evaluating a first predefined condition, the first predefined condition corresponding to the first communication channel between the first node group and the second node group;
a comparing module, the comparing module configured for:
comparing the first predefined condition with a second predefined condition, the second predefined condition corresponding to a second communication channel between the first node group and a third node group; and
comparing the first predefined condition with a fourth predefined condition, the fourth predefined condition corresponding to a third communication channel between the second node group and a fourth node group.
an associating module, the associating module configured for:
associating communication between the first node group and the third node group via the second communication channel based on an output of the comparing module; and
associating communication between the second node group and the fourth node group via the third communication channel based on the output of the comparing module.
a disassociating module, the disassociating module disassociating communication via the first communication channel between the second node group and the first node group.

21. A method of communication within a mobile node comprising:
communicatively coupling the mobile node with a first node group comprising a first plurality of mobile nodes having a first direction of movement and communicatively coupled within a first network;
communicatively coupling at least one of the first plurality of mobile nodes with a second node group comprising a second plurality of mobile nodes having a second direction of movement and communicatively coupled within a second network; and
communicating with at least one of the second plurality of mobile nodes by the mobile node via the at least one of the first plurality of mobile nodes.

22. A method of communication within a mobile node as claimed in claim 21 further comprising:
communicating with the at least one of the first plurality of mobile nodes by the mobile node using at least one communication route within the first network.

23. A method of communication within a mobile node as claimed in claim 21 further comprising:
communicating among the second plurality of nodes using at least one communication route within the second network.

24. A method of communication within a mobile node as claimed in claim 21 further comprising:
communicating a content request from the mobile node to a first source node of the first node group;
communicating the content request from the first source node to a second destination node of the second node group;
communicating the content request from the second destination node to the at least one of the second plurality of nodes;
communicating a content information from the at least one of the second plurality of nodes to a second source node of the second node group; and
receiving the content information by a first destination node in the first node group from the second source node; and
receiving the content information by the mobile node from the first destination node.
